(19) United States
(12) Patent Application Publication
(10) Pub. No.: US 2012/0177208 A1
(43) Pub. Date: Jul. 12, 2012

(54) TRIGGER GENERATING DEVICE, DISPLAY CONTROL DEVICE, TRIGGER GENERATING METHOD, DISPLAY CONTROL METHOD, TRIGGER GENERATING PROGRAM, AND DISPLAY CONTROL PROGRAM

(75) Inventors: Kazuhiro Fukuda, Kanagawa (JP); Ryosuke Tanaka, Saitama (JP); Takaharu Fujii, Kanagawa (JP)

(73) Assignee: SONY CORPORATION, Tokyo (JP)

(21) Appl. No.: 13/180,839

(22) Filed: Jul. 12, 2011

(30) Foreign Application Priority Data
Jul. 23, 2010 (JP) P2010-165636

(51) Int. Cl. H04R 29/00

(52) U.S. Cl. 381/56

(57) ABSTRACT

A trigger generating device includes: a level setting section detecting a maximum level of an audio signal in each predetermined period and setting a threshold with reference to the maximum level; and a trigger generating section comparing the audio signal and the threshold and generating a trigger signal when the level of the audio signal changes from a level smaller than the threshold to a level greater than the threshold.

### CROSS-REFERENCE TO RELATED APPLICATION

The present application claims priority from Japanese Patent Application No. JP 2010-165636 filed in the Japanese Patent Office on Jul. 23, 2010, the entire content of which is incorporated herein by reference.

### FIELD OF THE INVENTION

The present disclosure relates to a trigger generating device, a display control device, a trigger generating method, a display control method, a trigger generating program, and a display control program.

### BACKGROUND OF THE INVENTION

In the related art, various types of control are exercised in synchronism with the reproduction of audio data. For example, JP-A-2004-501497 (Patent Document 1) discloses control exercised to cause a plurality of LEDs to emit light according to the characteristics of audio data that is reproduced.

### SUMMARY OF THE INVENTION

Audio data such as music changes in various ways as the reproduction of the data proceeds. For example, a kind of music such as classic music may have loud instrumental tones input at the beginning of the same. Alternatively, such instrumental tones may be reproduced in the middle of the piece of music. In the case of a piece of music such as pop music, for example, loud vocal tones are reproduced when the climax of the music is reached. When some type of control is to be exercised in synchronism with a piece of music as thus described, it is desirable to trigger control at appropriate timing in accordance with changes in the audio data.

It is therefore desirable to provide a trigger generating device, a trigger generating method, and a trigger generating program for supplying a trigger at appropriate timing. It is also desirable to provide a display control device, a display control method, and a display control program for exercising display control in response to such a trigger.

An embodiment of the present disclosure is directed to a trigger generating device including: a level setting section detecting a maximum level of an audio signal in each predetermined period and setting a threshold with reference to the maximum level and a trigger generating section comparing the audio signal and the threshold and generating a trigger signal when the level of the audio signal changes from a level smaller than the threshold to a level greater than the threshold.

Another embodiment of the present disclosure is directed to a display control device including: a level setting section detecting a maximum level of an audio signal in each predetermined period and setting a threshold with reference to the maximum level, a trigger generating section comparing the audio signal and the threshold and generating a trigger signal when the level of the audio signal changes from a level smaller than the threshold to a level greater than the threshold, and a control section changing content displayed on a display section according to the trigger signal generated by the trigger generating section.

Still another embodiment of the present disclosure is directed to a trigger generating method including: detecting a maximum level of an audio signal in each predetermined period and setting a threshold with reference to the maximum level and comparing the audio signal and the threshold and generating a trigger signal when the level of the audio signal changes from a level smaller than the threshold to a level greater than the threshold.

Yet another embodiment of the present disclosure is directed to a display control method including: detecting a maximum level of an audio signal in each predetermined period and setting a threshold with reference to the maximum level, comparing the audio signal and the threshold and generating a trigger signal when the level of the audio signal changes from a level smaller than the threshold to a level greater than the threshold, and changing content displayed on a display section according to the trigger signal generated by the trigger generating section.

According to at least one embodiment of the present disclosure, a trigger can be appropriately generated according to the characteristics of an audio signal of interest. According to at least one embodiment of the present disclosure, display control can be exercised according to a trigger such that a pattern can be displayed in harmony with the reproduction of an audio signal of interest.

### BRIEF DESCRIPTION OF THE DRAWINGS

FIG. 1 is a block diagram showing an exemplary configuration of an in-vehicle audio apparatus;

FIG. 2 is a front view of an exemplary front panel of the in-vehicle audio apparatus;

FIG. 3 is a block diagram showing an exemplary configuration for generating a trigger signal;

FIG. 4A is a timing chart for explaining generation of a trigger signal;

FIG. 4B is a table for explaining generation of a trigger signal;

FIG. 5 is a flow chart of processes for detecting a maximum value as a level for determination;

FIG. 6 is a flow chart of processes for generating a trigger signal;

FIGS. 7A and 7B schematically shows exemplary color transition patterns; and

FIG. 8 is a table showing exemplary color switching patterns.

### DETAILED DESCRIPTION

An embodiment of the present disclosure will now be described with reference to the drawings. The following items will be described in the order listed.

### <1. Embodiment>

### <2. Modification>

The embodiment described below is a specific example of the present disclosure, and various technically preferable specifications are shown. However, the present disclosure is not limited to such an embodiment unless otherwise specified in the following description.

### Embodiment

### 1. Configuration of In-Vehicle Audio Apparatus

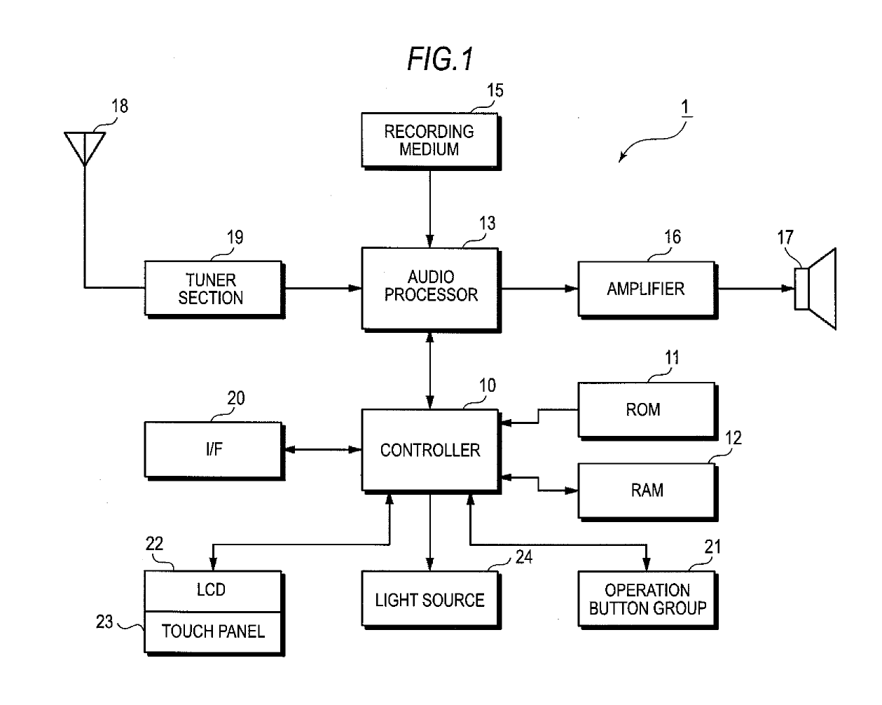

FIG. 1 shows an exemplary configuration of an in-vehicle audio apparatus 1. In the present embodiment, an in-vehicle audio apparatus will be described as an example of a trigger generating device and a display control device. However, the present disclosure is not limited to such an example. For example, the present disclosure is also applicable to stationary audio reproduction apparatus, portable audio reproduction apparatus, and personal computers having an audio reproduction function.

Referring to FIG. 1, the in-vehicle audio apparatus 1 includes a controller 10. For example, the controller 10 is constituted by a CPU (central processing unit). A ROM (read only memory) 11 and a RAM (random access memory) 12 are connected to the controller 10. For example, the controller 10 executes programs recorded in the ROM 11 to control various parts of the in-vehicle audio apparatus 1. The RAM 12 may be used as an area for temporarily storing a work memory or data of the controller 10 when the controller executes a process.

The controller 10 is connected to an audio processor 13. The audio processor 13 executes various processes on audio data under control exercised by the controller 10. For example, the processor executes a process of decoding compressed audio data and processes which will be described later.

A recording medium 15 is connected to the audio processor 13. For example, the recording medium 15 is a CD (compact disc) or a USB (universal serial bus) memory, and various types of audio data are recoded in the recording medium 15. The audio processor 13 reads out audio data recorded in the recording medium 15 under control exercised by the controller 10. Processes such as the decoding process are performed on the audio data thus read out by the audio processor 13. Audio data are supplied to an amplifier 16 after being processed as thus described. The audio data are amplified by the amplifier 16, and the amplified audio data are reproduced by a speaker 17.

Broadcast audio data may be supplied to the audio processor 13. For example, a broadcast signal received by an antenna 18 is supplied to a tuner section 19, and processes such as demodulation are performed on the signal. Audio data from the tuner section 19 are supplied to the audio processor 13. The in-vehicle audio apparatus 1 may be connected to an external apparatus through an interface 20, and audio data may be supplied from the external apparatus. Specifically, a mobile terminal may be connected to the in-vehicle audio apparatus 1 through the interface 20, and audio data transferred from the mobile terminal to the in-vehicle audio apparatus 1 may be supplied to the audio processor 13 under control exercised by the controller 10. Further, the in-vehicle audio apparatus 1 may be provided with, for example, a communication section (not shown) to supply audio data received through a network to the audio processor 13.

The in-vehicle audio apparatus 1 includes an operating button group 12, an LCD (liquid crystal display) 22, and a touch panel 23 provided in association with the LCD 22. For example, the operating button group 21 and the LCD 22 are disposed on features in the vicinity of the driver's seat such as an instrument panel or dash board. Obviously, the operation button group and the LCD may be disposed to be operated at a rear seat.

When the operation button group 21 is operated by a user, an operation signal is generated according to the operation, and the operation signal is supplied to the controller 10. The controller 10 performs a process associated with the operation signal. An operation signal associated with an operation in the form of a touch on the touch panel is supplied to the controller 10. The controller 10 exercises control according to the operation signal.

For example, when a user performs an operation of selecting a piece of music using the operation button group 21, the controller 10 generates a control signal for reading out the selected audio data. The control signal is supplied to the audio processor 13, and the audio processor 13 reads out audio data associated with the signal from the recording medium 15 or the like according to the control signal and reproduces the audio data.

The controller 10 controls a light source 24. For example, the light source 24 is a device capable of emitting in a multiplicity of colors. For example, the light source is constituted by LEDs (light-emitting diodes) of three primary colors. The light source 24 is located on a rear surface of the LCD 22 to serve as a backlight for the LCD 22. Further, the light source 24 is disposed such that light from the same illuminates the buttons of the operation button group 21 and the neighborhood of the same from the rear side thereof. The colors of the light source 24 are switched under control exercised by the controller 10. When the colors are switched as thus described, the color displayed by the LCD 22 and the color of each button of the operation button group 21 are changed.

### 2. Configurations of the Operation Button Group and LCD

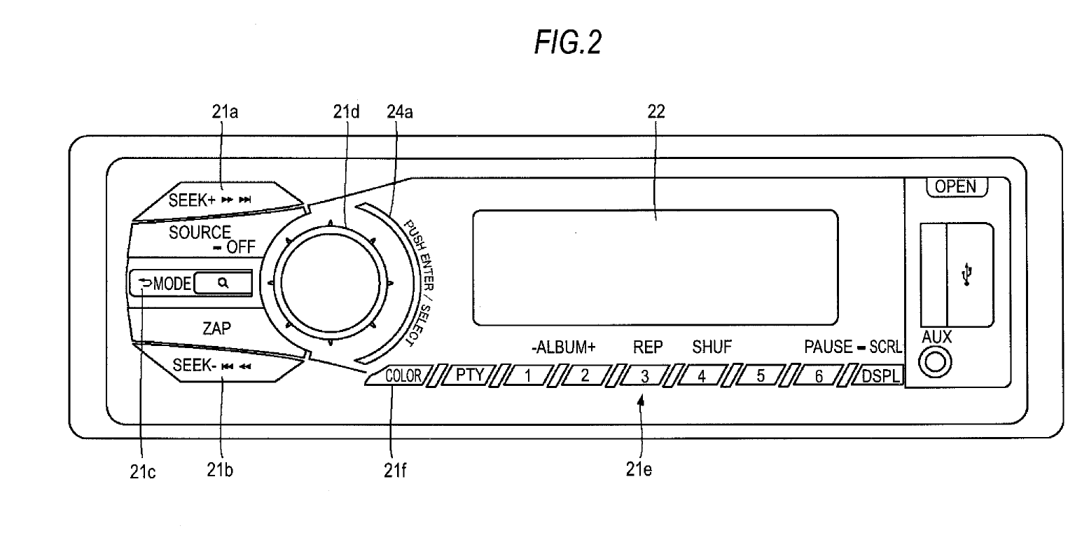

FIG. 2 shows an example of a front panel of the in-vehicle audio apparatus 1. The buttons of the operation button group 21 and the LCD 22 are disposed on the front panel. Other operation buttons disposed on the panel include a button 21a used for fast-forward and skip operations, a button 21b used for rewind and return operations, and a button 21c used for mode setting. Further, the buttons include a dial-type button 21d which is rotated and depressed for various types of setting and selecting operations, buttons 21e for selecting preset broadcast stations, and a color button 21f for setting a display color.

A light source 21 is disposed behind the LCD 22 and the operation buttons. When the color of light emitted by the light source 24 changes, the operation button group 21 is displayed in a different color. For example, the parts of the buttons 21a and 21b in the form of black triangles may be displayed in various colors such as red and blue. The color of an arrow-like part of the button 21c and numerals of the buttons 21e may be changed. Not only the colors of symbols and numerals as described above, but also the colors of characters (e.g., the characters “SEEK” on the buttons 21a and 21b and the characters “MODE” on the button 21c) may be changed.

Further the light source 24 is not limited to the configuration in which it commonly serves the operation button group 21 and the LCD 22. That is, the operation button group 21 and the LCD 22 may be accompanied by separate light sources to serve them respectively. Further, each of the operation buttons may be accompanied by a dedicated light source. Further, such light sources may be provided independently of the operation button group 21. For example, a light source 24a having an arcuate shape may be provided near the dial-type button 21d, and the color of the light source 24a may be changed appropriately. As thus described, the disposition of the buttons of the operation button group 21 may be changed as occasion demands. The part of each button displayed in different colors may be also changed as occasion demands.

The LCD 22 is disposed near the operation button group 21. Various types of information may be displayed on the LCD 22, the information including, for example, the title of a track of a CD which is presently reproduced and the frequency of a broadcast station. The LCD 22 may be used as an area for displaying various modes and settings of the apparatus. The light source 24 to serve as a backlight is provided behind the LCD 22. The color of characters or symbols displayed on the LCD 22 is changed by changing the color of the light source 24.

### 3. Outline of Processes

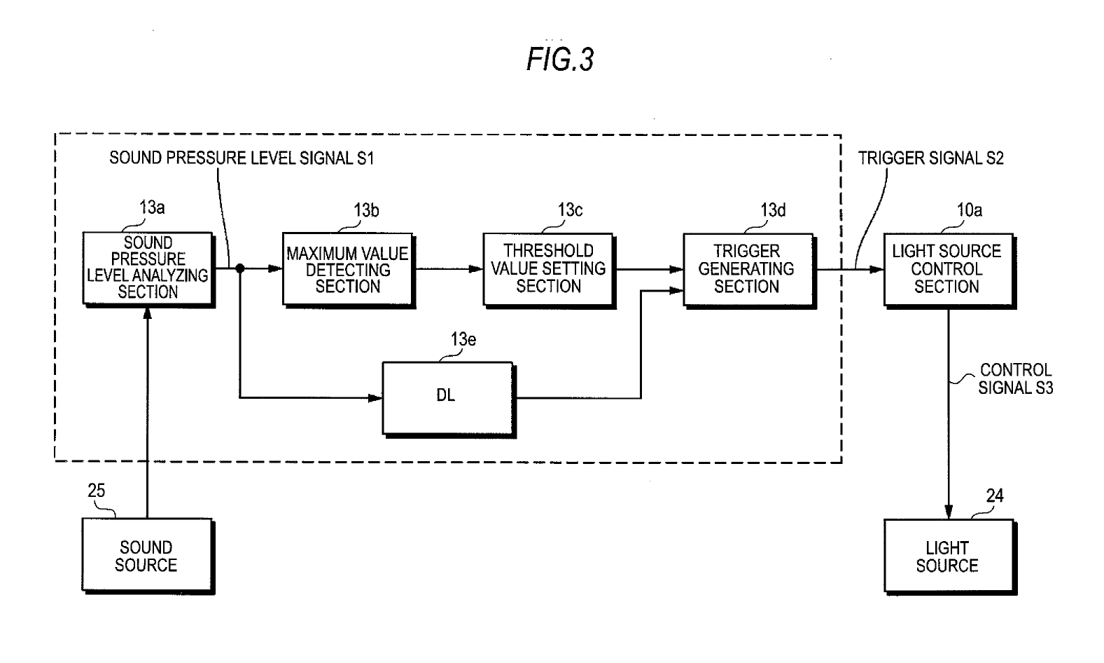

Processes executed by the in-vehicle audio apparatus 1 of the present embodiment will now be briefly described with reference to FIG. 3. A sound source 25 is collectively formed by the recording medium 15 shown in FIG. 1, broadcast waves received through the antenna 18, and an external apparatus connected to the apparatus 1 through the interface 20.

For example, a digital audio signal is supplied from the sound source 25 to a sound pressure level analyzing section 13a. A sound pressure level signal S1 obtained by the sound pressure level analyzing section 13a is supplied to a maximum value detecting section 13b. A maximum value detected by the maximum value detecting section 13b is supplied to a threshold setting section 13c. A threshold set by the threshold setting section 13c is supplied to a trigger generating section 13d. The sound pressure level signal S1 from the sound pressure level analyzing section 13a is supplied to the trigger generating section 13d through a delaying section 13e for timing. A sound-interlocked signal generating unit is formed by the maximum value detecting section 13b, the threshold setting section 13c, and the trigger generating section 13d. The sound-interlocked signal generating unit and the delaying section 13e are functional units of the audio processor 13, and they may be implemented not only on a hardware basis but also on a software basis.

At the sound pressure level analyzing section 13a, the sound pressure level of audio data is detected, and a trigger signal S2 is generated from a sound pressure level signal S1 representing the sound pressure level. A threshold is set based on a maximum value detected by the maximum value detecting section 13b. When the sound pressure level signal S1 exhibits a predetermined change relative to the threshold thus set, the trigger signal S2 is generated. The relationship between a change in the sound pressure level signal S1 and the generation of the trigger signal S2 will be detailed later.

The trigger signal S2 is supplied to a light source control section 10a. The light source control section 10a is a functional unit of the controller 10. The controller 10 exercises various types of control according to a trigger signal S2 supplied thereto. In this embodiment, for example, the controller 10 performs controls the light source 24 to change the colors of the operation button group 21 and the LCD 22.

Specifically, when a trigger signal S2 is supplied, the light source control section 10a of the controller 10 generates a control signal S3. The control signal S3 is supplied from the light source control section 10a to the light source 24. For example, the color of the light source 24 is specified by the control signal S3. When a plurality of light sources 24 are provided in different locations in such a manner that they can be individually controlled, the control signal S3 specifies light sources to emit light. The light sources 24 emit light according to the control signal S3. As a result of the emission of the light sources 24 which may be LEDs, the operation button group 21 and the LCD 22 emit light.

### 4. Trigger Signal Generating Process

A trigger signal is generated in conjunction with a piece of music represented by an audio signal from the sound source 25. Specifically, a maximum level m of the audio signal in each predetermined period, e.g., in each one-second period is detected by the maximum value detecting section 13b, and a threshold is set by the threshold setting section 13c with reference to the maximum level m. Maximum values may alternatively be detected at intervals of 30 ms instead of one second. At the trigger generating section 13d, the audio signal is compared with thresholds set as thus described. Each sample of the audio signal is categorized as a high level (a flag F is set to 1), a low level (the flag F is set to 0), or an intermediate level (which may alternatively be called an indefinite level) residing between the high and low levels. When the flag changes from 0 to 1, a trigger signal S2 is generated.

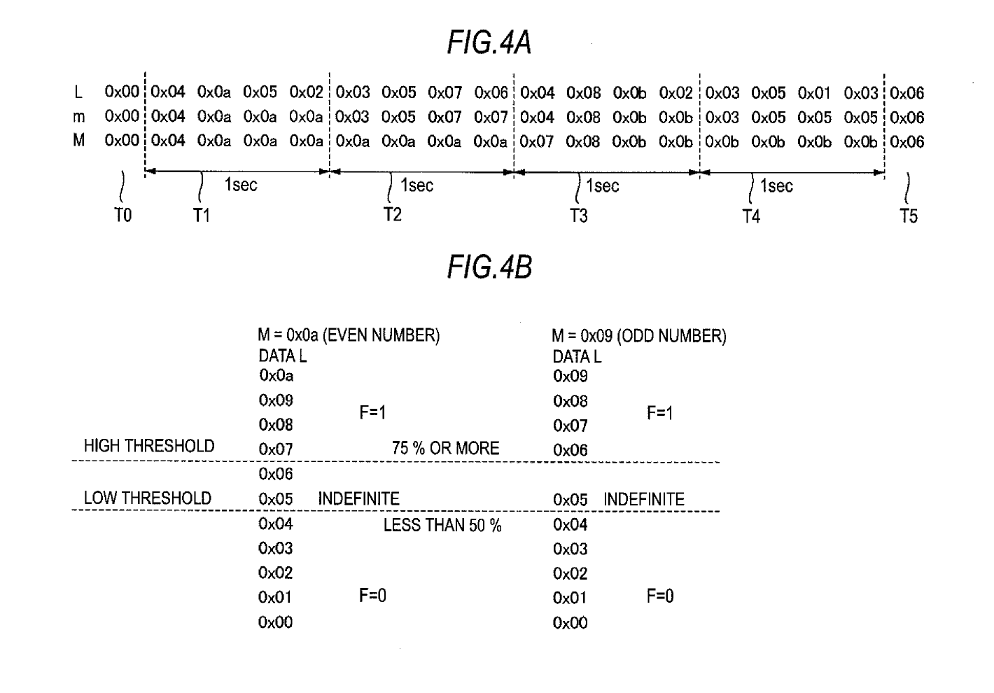

FIG. 4A shows an example of an input level L of audio data (a sound pressure level signal) Si. For example, four samples are obtained from the audio data S1 every second, and each sample has an input level L in hexadecimal notation (represented by “0x”). The maximum value detecting section 13b detects a maximum value m in each one-second period, and the maximum value is retained during the one-second period. For example, a value “0×0a” is detected as a maximum value m in a first one-second period T1 shown in FIG. 4A, and the detected maximum value m is retained. The maximum value m of each one-second period is refreshed in the next one-second period. For example, the maximum value “0×0a” in the period T1 in FIG. 4A is refreshed at the beginning of the next period T2. Then, a maximum value “0×07” in the next period T2 is detected.

A maximum value detected in each one-second period (which will be hereinafter referred to as “one second maximum value”) m is retained, and such a maximum value is refreshed every second. Thus, data of a retained maximum value M which is refreshed every second (the bottom row of data in FIG. 4A) are generated. At transition between the period T2 and a period T3, the one-second maximum value “0×07” obtained in the period T2 is refreshed, and the retained maximum value M is also refreshed from “0×0a” into “0×07”.

At transition between a period T4 and a period T5, a one-second maximum value “0×05” obtained in the period T4 is refreshed. However, the retained maximum value M becomes “0×06” instead of being refreshed into “0×05”. The reason is that the value “0×06” of the first sample in the period T5 is greater than the retained maximum value M (“0×05”).

A maximum value detecting process is performed as thus described, and the threshold value setting section 13c sets a low threshold and a high threshold from the retained maximum value M, as shown in FIG. 4B. Specifically, the section 13c sets a high level threshold above which the flag F is set to 1 to represent data having a value equal to or greater than 75% of the retained maximum value M and a low level threshold below which the flag F is set to 0 to represent data having a value less than 50% of the retained maximum value M. FIG. 4B shows thresholds which are set when the value M is “0×0a” (even number) and when the value M is “0×09” (odd number).

When the value M is “0×0a”, thresholds are set such that “0×00” to “0×04” are determined as values for which the flag F is to be set to 0; “0×05” to “0×06” are determined as indefinite values; and “0×07” to “0×0a” are determined as values for which the flag F is to be set to 1. When the value M is “0×09”, thresholds are set such that “0×00” to “0×04” are determined as values for which the flag F is to be set to 0; “0×05” is determined as indefinite values; and “0×06” to “0×09” are determined as values for which the flag F is to be set to 1. The detection of maximum values and setting of thresholds are carried out as described above by the maximum value detecting section 13b ad the threshold setting section 13c. When the flag F change from 0 to 1, a trigger signal S2 is output from the trigger generating section 13d.

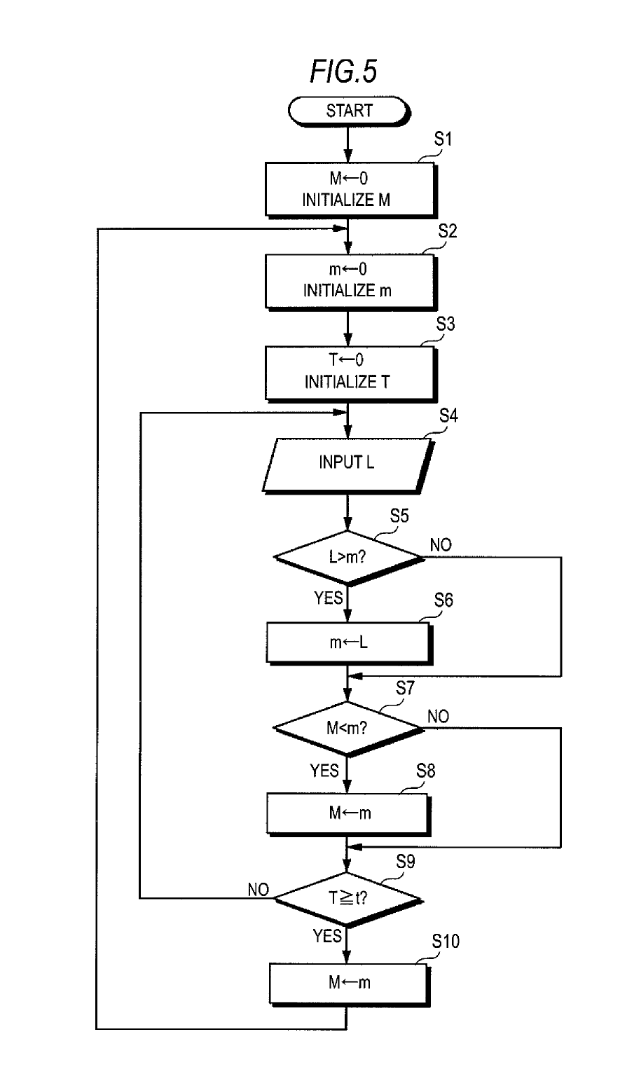

The retained maximum value M as a reference sound pressure level is determined according to a procedure represented by the flow chart of FIG. 5. The reference characters in FIG. 5 have meanings as shown below.

M: retained maximum value

L: input level

T: elapsed time (in seconds)

t: interval for updates in seconds (e.g. one second)

m: maximum value in preceding one second

At step S1 that is the first step of the procedure, the value of the retained maximum value M is initialized (to 0). At step S2, the maximum value in the preceding one second is initialized (to 0). At step S3, the value of the elapsed time T (in seconds) is initialized (to 0).

At step S4, one sample of audio data having a level L is input. It is determined at step S5 whether “L>m” is true or not. If it is determined that “L>m” is true, the input level L is set as the maximum value m of the preceding one second (step S6). If “L≦m” is true, the present maximum value m is retained.

For example, initialization at steps S1, S2, and S3 may be carried out in the period T0 shown in FIG. 4A. Since the level L of the first sample is “0×04”, the one-second maximum value m is set at “0×04” by the process at step S6.

At step S7, it is determined whether “M<m” is true or not. If it is determined that “M<m” is true, the one-second maximum value m is set as the retained maximum value M (step S8). When “M≧m” is true, the retained maximum value M is kept unchanged. At the next step or step S9, it is determined whether “T≧t” is true or not. When the elapsed time T is shorter than the interval for updates t (e.g., one second), the flow returns to step S4, and the above-described processes at steps S5 to S8 are repeated.

For example, the level L of the next sample of the input audio data in the period T1 is “0×0a”, the one-second maximum value m is set at “0×0a” by the process at step S6. It is determined at step S7 that “0×04”<“0×0a” is true, and “0×0a” is therefore set as the retained maximum value M at step S8. Then, the flow returns to step S4.

In the example shown in FIGS. 4A and 4B, when the fourth sample is input and subjected to the processes at steps S4 to S8, it is determined at step S9 that “T≧t” is true. Then, step S10 is executed to set the one-second maximum value m as the retained maximum value M. The flow then returns to step S2, and similar processes are carried out for the next one-second period. In this case, the retained maximum value M is not initialized because the process at step S1 is not performed.

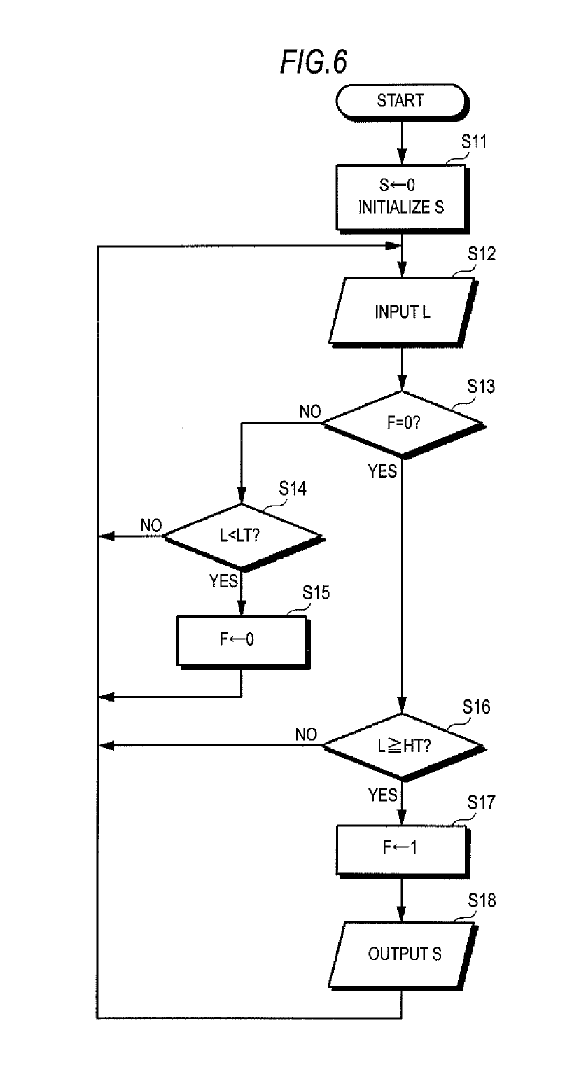

A trigger signal S2 as a sound-interlocked signal is generated according to the procedure represented by the flow chart shown in FIG. 6. Reference characters in FIG. 6 have meanings as shown below.

S: trigger signal

F: determination flag

L: input level

HT: high threshold

LT: low threshold

In the above-described example, the high threshold HT is a value that is 75% of the retained maximum value M, and the low threshold LT is a value that is 50% of the retained maximum value M. For simplicity, let us now assume that the high threshold HT equals the low threshold LT which equals 50% of the retained maximum value M and that there is no indefinite region. At step S1 or the initializing step at the beginning of the procedure, the trigger signal is set to 0.

When the input level L of audio data is input at step S12, it is determined at step S13 whether the determination flag F is set to 0 for determining the preceding input level. When it is determined that the value of the determination flag F is not 0 or when the value of the flag F is 1, it is determined at step S14 whether “L<LT” is true or not. When it is determined that “L<LT” is true, the determination flag F is set to 0 (step S15). When it is determined that “L<LT” is not true, the determination flag F is not changed. Then, the flow returns to step S12 (input of an input level L).

When it is determined at step S13 that the value of the determination flag F is 0, it is determined at step S16 whether “L≧HT” is true or not. When “L≧HT” is not true, the flag F is not changed, and the flow returns to step S12 (input of an input level L). When it is determined at step S16 that “L≧HT” is true, the flag F is set to 1 at step S17. Since the value of the determination flag F is changed from 0 to 1, a trigger signal S (S2) is output at step S18.

5. Processing of Output Data from Spectrum Analyzer

Results of an analysis of a music signal carried out using a spectrum analyzer are displayed on the display screen of the LCD 22 of the in-vehicle audio apparatus while the music signal is reproduced. For example, the band of the audio signal is divided into a plurality of bands, e.g., seven bands, and the level of the audio signal in each band is detected. Changes in the detected level of the audio signal are converted into a display pattern, and the pattern is displayed on the screen of the LCD 22.

An output signal from a detector of a spectrum analyzer for detecting the level of each band may be used as the sound source 25 among the features described above as shown in FIG. 3. Therefore, the features shown I FIG. 3 are provided for each of a plurality of bands, e.g., seven bands, and a trigger signal is generated for each band. In this case, a maximum value detecting function of the spectrum analyzer may be used to detect a maximum value in each predetermined period. Trigger signals generated in the seven bands respectively are ORed, and the result is output as a trigger signal. Alternatively, trigger signals may be generated in some of the seven bands, e.g., some lower and medium bands, and the signals may be ORed to output a trigger signal.

### 6. Example of Display Control

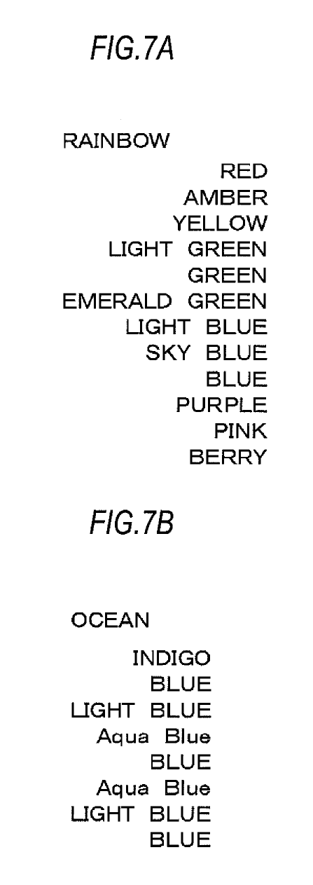

The display control section 10a receives a trigger signal generated as described above and controls the light source 24 to switch a displayed color into another. In order to change a displayed color, a color transition pattern is prepared, the pattern having a plurality of colors for which an order of color transitions is set in advance. As shown in FIG. 7A, a color transition pattern named “rainbow” causes twelve colors to be sequentially switched starting with red each time a trigger signal is generated.

A color transition pattern named “ocean” shown in FIG. 7B causes eight colors having similar hues (blue (cold color) family) to be sequentially switched each time a trigger signal is generated. Although not shown, it is possible to use a color transition pattern named “sunset” including a plurality of colors belonging to the red (warm color) family or a color transition pattern named “forest” including a plurality of colors belonging to the green family.

Further, a color transition pattern for switching 23 colors at random may alternatively be used. A plurality of color transition patterns as thus described are set as user options. Alternatively, such patterns may be automatically switched according to the tune of the audio signal to be reproduced.

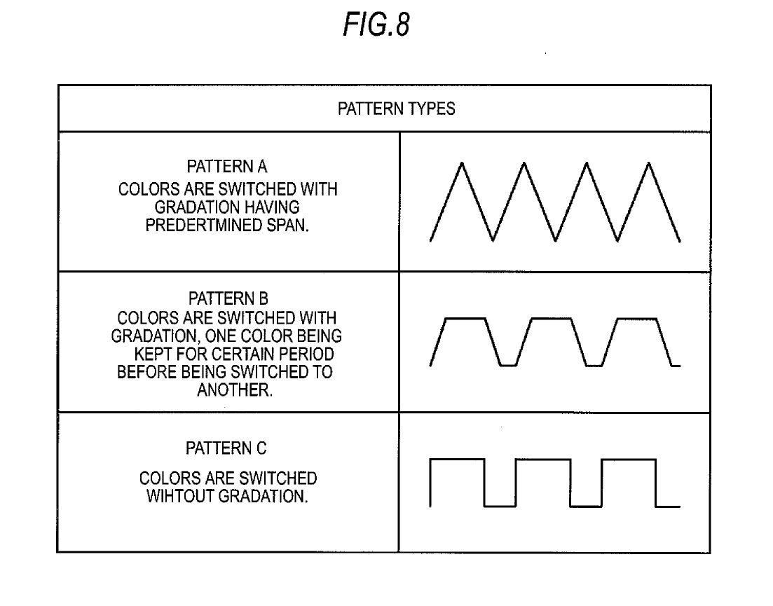

As shown in FIG. 8, a color switching pattern may be used, which allows colors to be switched with steepness of transition depending on the trigger signal used. A pattern A is a pattern for switching colors with gradation having a predetermined span. A pattern B is a pattern for switching colors with gradation, the pattern allowing one color to be kept for a predetermined period before being switched into another color. A pattern C is a pattern which allows one color to be switched to another directly.

The pattern A results in color transitions with gentle steepness, and resultant colors will therefore be displayed with a gentle impression. The pattern C results in color transitions with high steepness, and resultant colors will therefore be displayed with a more striking impression. The pattern B allows colors to be displayed with an impression which is intermediate between the impressions given by the patterns A and C. Those patterns are set as user options. The patterns may be automatically switched according to the color transition pattern used as described above or the tune of the audio signal to be reproduced.

### Modifications

According to the above description, an LCD is used as the display device of the embodiment. Alternatively, a self-emission display device requiring no backlight may be used. Further, the present disclosure is not limited to the switching of a displayed color using a trigger signal generated as thus described, and the disclosure is applicable to the switching of brightness.

It should be understood by those skilled in the art that various modifications, combinations, sub-combinations and alterations may occur depending on design requirements and other factors insofar as they are within the scope of the appended claims or the equivalents thereof.

What is claimed is:

1. A trigger generating device comprising:
a level setting section detecting a maximum level of an audio signal in each predetermined period and setting a threshold with reference to the maximum level; and
a trigger generating section comparing the audio signal and the threshold and generating a trigger signal when the level of the audio signal changes from a level smaller than the threshold to a level greater than the threshold.

2. A trigger generating device according to claim 1, wherein
the level setting section divides the audio signal into a plurality of bands and generates the trigger signal for an audio signal in each of the bands; and
the trigger signal is output when the trigger signal is generated in association with an audio signal in any of the plurality of bands.

3. A display control device comprising:
a level setting section detecting a maximum level of an audio signal in each predetermined period and setting a threshold with reference to the maximum level;
a trigger generating section comparing the audio signal and the threshold and generating a trigger signal when the level of the audio signal changes from a level smaller than the threshold to a level greater than the threshold; and
a control section changing content displayed on a display section according to the trigger signal generated by the trigger generating section.

4. A display control device according to claim 3, wherein
the level setting section divides the audio signal into a plurality of bands and generates the trigger signal for an audio signal in each of the bands; and
the trigger signal is output when the trigger signal is generated in association with an audio signal in any of the plurality of bands.

5. A display control device according to claim 3, wherein the control section controls the display section such that a color on the display section is changed to another at the timing of the trigger signal.

6. A display control device according to claim 3 further comprising a plurality of color transition patterns for which an order of color transitions between a plurality of colors is set in advance, wherein
the control section controls the display section such that colors in the color transition patterns are switched at the timing of the trigger signal.

7. A display control device according to claim 6, wherein the plurality of color transition patterns are series of a plurality of colors having similar hues.

8. A display control device according to claim 3, wherein plural levels of steepness are defined for transitions caused by the trigger signal, and the steepness of a transition is determined according to the tune of the audio signal.

9. A trigger generating method comprising:
detecting a maximum level of an audio signal in each predetermined period and setting a threshold with reference to the maximum level; and
comparing the audio signal and the threshold and generating a trigger signal when the level of the audio signal changes from a level smaller than the threshold to a level greater than the threshold.

10. A program of a trigger generating method causing a computer to perform an operation comprising:
detecting a maximum level of an audio signal in each predetermined period and setting a threshold with reference to the maximum level; and
comparing the audio signal and the threshold and generating a trigger signal when the level of the audio signal changes from a level smaller than the threshold to a level greater than the threshold.

11. A display control method comprising:
detecting a maximum level of an audio signal in each predetermined period and setting a threshold with reference to the maximum level;
comparing the audio signal and the threshold and generating a trigger signal when the level of the audio signal changes from a level smaller than the threshold to a level greater than the threshold; and
changing content displayed on a display section according to the trigger signal generated by the trigger generating section.

12. A program of a display control method causing a computer to perform an operation comprising:
detecting a maximum level of an audio signal in each predetermined period and setting a threshold with reference to the maximum level;
comparing the audio signal and the threshold and generating a trigger signal when the level of the audio signal changes from a level smaller than the threshold to a level greater than the threshold; and
changing content displayed on a display section according to the trigger signal generated by the trigger generating section.
